(19) United States
(12) Patent Application Publication
(10) Pub. No.: US 2024/0137358 A1
(43) Pub. Date: Apr. 25, 2024

(54) PEER-TO-PEER SECURITY STATUS DETECTION

(71) Applicant: VMware, Inc., Palo Alto, CA (US)

(72) Inventors: Ramanandan Nambannor Kunnath, Bangalore (IN); Rohit Pradeep Shetty, Bangalore (IN); Erich Stuntebeck, Johns Creek, GA (US)

(21) Appl. No.: 17/969,498

(22) Filed: Oct. 18, 2022

(51) Int. Cl. H04L 9/40; H04L 67/141

(52) U.S. Cl. CPC H04L 63/0823; H04L 67/141

(57) ABSTRACT

Disclosed are various approaches for peer-to-peer device security detection. In some examples, a first client device transmits verification data to a second client device. The verification data includes a public key verification certificate of the client device, and a time-based session token generated by the first client device. The first client device receives a preliminary cross-comparison package from the second client device. The preliminary package includes a spoof-check token, and peer device context data of the second client device. The first client device generates a cross-comparison package using the preliminary cross-comparison package and local device context data of the first client device, and transmits the cross-comparison package to a management service for cross-comparison.

### BACKGROUND

An enterprise can use a management service to manage devices, including security settings and access to enterprise data. In order to perform all the functions associated with managing devices, a management service can leverage periodically provided device parameters to check device security and compliance against expected or required settings. The current security landscape however can include devices and programs that are capable of spoofing data to prevent accurate detection of security issues from sensor readings to enrollment status. This complicates detecting whether a device is compromised or unenrolled with the management service employed by the enterprise. These spoofing frameworks can hook on to various system APIs and otherwise return spoofed data to the management service.

One solution can be to blacklist applications that can perform spoofing operations and otherwise circumvent management service security checks. However, this approach requires the management service to be aware of the specific application in order to implement a blacklist. The resulting security hole for new or obscure security threats can comprise enterprise security and management service efficacy. As a result, there is a need for advancements in the area of security issue detection.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram depicting an example of a network environment, according to examples of the disclosure.

FIG. 2 depicts a peer-to-peer security status detection scenario using components of the networked environment, according to examples of the disclosure.

FIG. 3 is a flowchart depicting an example of a peer-to-peer security status detection operation performed by components of the networked environment, according to examples of the disclosure.

FIG. 4 is a flowchart depicting another example of a peer-to-peer security status detection operation performed by components of the networked environment, according to examples of the disclosure.

FIG. 5 is a flowchart depicting another example of a peer-to-peer security status detection operation performed by components of the networked environment, according to examples of the disclosure.

### DETAILED DESCRIPTION

Disclosed are examples of systems and methods for peer-to-peer security status detection between client devices enrolled with a management service. The management service can leverage periodically provided parameters to check device security and compliance against expected or required settings. Some programs can spoof or provide false data to prevent accurate detection of security status issues. This can include spoofed sensor readings, network connectivity, enrollment status, and other spoofed parameters. This complicates detecting whether a device is compromised or unenrolled with the management service employed by the enterprise. While existing solutions can blacklist applications that can perform spoofing operations, this approach requires the management service to be aware of a specific application in order to implement a blacklist. As a result, new or obscure security threats can present a security risk that comprises enterprise security and management service efficacy. However, the present disclosure describes mechanisms that are capable of identifying security status issues such as noncompliant devices without using a blacklist. For example, the mechanisms described herein can use peer-to-peer device communications and ultimately compare device parameters with that of nearby devices to identify security status issues. This enables a more effective approach than existing technologies that require specific knowledge of spoofing programs in order to prevent their use.

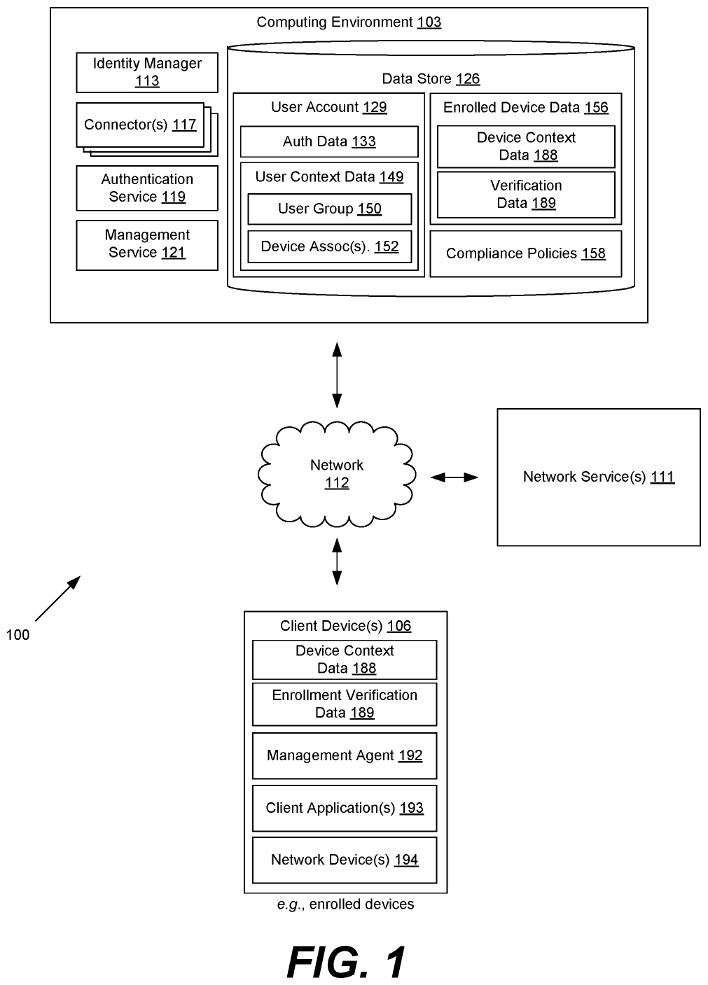

Beginning with FIG. 1, shown is an example of a networked environment 100. The networked environment 100 includes a computing environment 103, a network service 111, as well as a number of client devices 106, which are all capable of data communication with each other across one or more networks 112.

A network 112 includes wide area networks (WANs) and local area networks (LANs). These networks can include wired or wireless components or a combination thereof. Wired networks can include Ethernet networks, cable networks, fiber optic networks, and telephone networks, such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks. A peer-to-peer communication channel can include direct client device 106 to client device 106 communications over a network 112. The network 112 can include permanent and ad-hoc networks 112, networks 112 generated by the client devices 106 themselves, and device-to-device communications over networks 112 provided or facilitated using routers and other devices.

The computing environment 103 can include, for example, a server computer or any other system providing computing capability. Alternatively, the computing environment 103 can employ a plurality of computing devices that can be arranged, for example, in one or more server banks or computer banks or other arrangements. These computing devices can be located in a single installation or can be distributed among many different geographical locations. For example, the computing environment 103 can include a plurality of computing devices that together can include a hosted computing resource, a grid computing resource, or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103 according to various examples. The components executed in the computing environment 103, for example, can include an identity manager 113, one or more connectors 117, an authentication service 119, and a management service 121.

The identity manager 113 can authenticate users and manage user authorizations or permissions to access applications, data, or other computing resources. For example, the identity manager 113 can correspond to a single sign-on portal that verifies a user's authentication data 133, which can include authentication credentials, a single sign-on token that identifies the user, and verifies whether the user has the appropriate access and permissions to access enterprise data and functionalities of the computing environment 103 and/or one or more network services 111 according to the compliance policies 158. The network services 111 which can include services that can provide user access to enterprise data. Examples of identity managers 113 include VMWARE's Identity Manager, Workspace ONE®, or MICROSOFT's Active Directory Federation Services.

A connector 117 can provide a standardized mechanism for the assistant connection service to communicate with a network service 111. Each network service 111 may provide an application programming interface (API) for communicating, querying, or otherwise interacting with the network service 111, which can include different methods or functions with different parameters compared to other network services 111. This can allow for the assistant connection service to send a single, uniformly formatted query to one or more connectors 117. Each connector 117 is then responsible for using the information provided in the query from the assistant connection service to invoke the appropriate functions provided by the API of the network service 111. To add support for a new network service 111, a new connector 117 can be created without needing to modify the assistant connection service itself. Likewise, if a change is made to the API of the network service 111, the connector 117 between the assistant connection service and the federated service can be updated without having to modify the assistant connection service itself.

The authentication service 119 can retrieve and cache authentication data, such as authentication tokens and refresh tokens, provided by various network services 111 accessible over a network 112. The cached authentication data can be used by the assistant connection service to query the network services 111 for information.

A data store 126 can store information and data that is accessible to the computing environment 103. The data store 126 can be representative of a plurality of data stores, which can include relational databases, object-oriented databases, hierarchical databases, hash tables or similar key-value data stores, as well as other data storage applications or data structures. The data stored in the data store 126 is associated with the operation of the identity manager 113, the connector(s) 117, the authentication service 119, the management service 121, and one or more of the network services 111, as well as potentially other applications or functional entities as described later. This data can include one or more user accounts 129 and potentially other data.

The user account 129 represents information associated with a user. The information can include authentication data 133. The authentication data 133 can include one or more authentication credentials, one or more single sign-on tokens, and/or one or more access permissions applied to the user account, as well as cached authentication tokens and refresh tokens. The user account 129 can be associated with a compliance policy 158, as well as one or more client devices 106. In some examples, a compliance policy 158 can be applied to all client devices 106 associated with a particular user account 129 or a particular user group 150. One or more compliance policies 158 can be applied to a single client device 106. In some examples, a specific compliance policy 158 can be created for a particular client device 106 as well.

Authentication credentials represent the credentials that a user can present to the identity manager 113 to authenticate the user's identity. Authentication credentials can include a combination of a username and password, a cryptographic certificate, a one-time password, or a combination of several of the authentication credentials as part of a multi-factor authentication schema. Examples of one-time passwords can include a one-time password generated using a version of the time-based one-time password (TOTP) algorithm or a one-time password generated using the HMAC-based one-time password (HOTP) algorithm.

A single sign-on (SSO) token is a software token generated by the identity manager 113 in response to a successful authentication of the user with the identity manager 113 using the authentication credentials. The SSO token can be used to provide a client device 106 access to various network services 111 on behalf of the authenticated user. Additionally, the SSO token can be used by the assistant connection service to access various network services 111 on behalf of the authenticated user. In some instances, such as those implementing a version of the KERBEROS protocol, a separate SSO token can be generated for each network service 111 that the client device 106 attempts to access on behalf of the user. In other instances, the SSO token can be generated and used to provide the client device 106 with access to several of the network services 111. Although each of the network services 111 can have a different set of authentication credentials linked to the user account 129, such as a different username and password combination, the SSO token allows the user to authenticate once with the identity manager 113 in order to use each of the network services 111 instead of having to authenticate with each of the network services 111 separately.

The access permissions represent computing resources that the user account is authorized to access. For example, the access permissions can indicate that a user account is permitted to access some network services 111 but is prohibited from accessing other network services 111. As another example, the access permissions can indicate that the user account 129 can access certain features of a network service 111 but prohibited from accessing other features. For example, if one of the network services 111 that a user was permitted to access was a customer relationship management (CRM) service, the user might have permission to access his or her own contacts but be prohibited from accessing the sales contacts of other users. In some implementations, the access permissions can be defined at a user group level rather than at a user level in a directory service.

An authentication token is a token provided by the identity manager 113 or the network service 111 in response to a successful authentication of the user. The authentication token represents that a user account 129 is currently authenticated to access a network service 111 and authorized to access or otherwise interact with the network service 111 in some capacity. For security purposes, the authentication token often has a time-limit associated with it, (such as 1 hour, 3 hours, 6 hours, 8 hours, or some other period of time). Once the time-limit has expired, the authentication token can no longer be used to prove current authentication status of the user account 129 with the network service 111. The authentication token can be provided, for example, as part of an authentication exchange using a version of the OAUTH protocol.

A refresh token is a token provided by one of the network services 111 in response to a successful authentication with the network service 111. The refresh token can be used to acquire a new authentication token once a current or previous authentication token expires. The refresh token often has a much longer time-limit associated with it, such as 1 day, 1 week, 30 days, 3 months, or 1 year, which allows for the refresh token to be used to acquire a series of authentication tokens after an initial successful authentication. In the event that a user's access is revoked, the refresh token can be marked invalid, preventing the refresh token from being used to acquire new authentication tokens. The refresh token can be provided, for example, as part of an authentication exchange using a version of the OAUTH protocol.

The user context data 149 can include meta-data such as a job title, role title and description, work history, and other stored information. For example, the user context data 149 can include a user group 150 and device associations 152. Each of the items of the user context data 149 can include both new datapoints and a history of datapoints for the data indicated.

The user group 150 can include a group such as users in a department, team, building, campus, or site including a group of buildings, a branch of the organization that the user belongs to, and so on. Some users can belong to multiple user groups 150 and subgroups. The user group 150 data can also provide an identification or name for the group and any subgroups. For example, an organizational branch, a business unit or department, a team, and other subgroups can be indicated.

The device associations can identify client devices 106 that are used by, owned by, or otherwise assigned to or associated with the user account 129. In some examples, a compliance policy 158 associated with the user account 129 or user group 150 of the user account 129 can be applied to the client devices 106 of the user account 129 and/or user group 150.

The data store 126 can also include enrolled device data 156. The enrolled device data 156 can include information about states and user account 129 device associations 152 for each client device 106 that is enrolled with the management service 121. The enrolled device data 156 can include device context data 188, verification data 189, and other information about enrolled client devices 106.

Device context data 188 can include device location data, sensor data, network data, peer device data, and other states and information associated with device identifiers for the client devices 106. Device context data 188 can be timestamped, and can also include heartbeat data. Device context data 188 for one client device 106 can be compared to that of a nearby peer client device 106 to determine whether one of the devices is compromised. Nearby client devices 106 can be connected to the same networks 112, can have the same location, can detect the same networks 112, can detect the same nearby peer devices over peer-to-peer networks, can sense the same environmental sensor data such as audio data, light characteristic data, and so on. As a result, the device context data 188 can include shared information that can be used to identify whether a client device 106 is compromised.

Location data can include the geographical location of a client device 106 associated with the user account 129 of a user. The location data can also include a history of locations of the client device 106. The location data can be identified using GPS, network connection, triangulation, and other methods. Sensor data can include GPS and other location data; elevation data; barometric pressure data; altitude data; humidity data; camera, infrared and other optical data; microphone and audio data; and other environmental data. Device context data 188 can further include network data such as a list of available network identifiers such as SSIDs for each network device 194 or network type such as Bluetooth, WiFi, BLE, Zigbee, and network types that use other network protocols. Peer device data can include a list of detectable devices connected to a corresponding network identifier. The device context data 188 can be collected and stored in the data store 126. The network devices 194 can include Bluetooth devices, WiFi devices, BLE devices, Zigbee devices, and network devices 194 that use other network protocols.

The device context data 188 can be detected by management agents 192 for each client device 106. The device context data 188 can be detected and stored in each client device 106, and can also be provided to the management service 121 for comparison and peer-to-peer security status detection purposes as discussed herein. The management service 121 can store a history of device context data 188 for each client device 106.

Verification data 189 can include a device identifier such as a unique device identifier (UDID), globally unique identifier (GUID), and/or universally unique identifier (UUID) that is assigned to a client device 106 by the management service 121 upon enrollment. The verification data 189 can also include a public key such as a public key peer-to-peer verification certificate, a private key for one or more client devices 106, and other information.

Each network service 111 can be associated with a federated user account. A user with a user account 129 may also have multiple federated user accounts. For example, a user may have one federated user account for each network service 111 that the user is registered or enrolled with. As another example, the user may have multiple federated user accounts for a network service 111 (e.g., a personal federated user account and a separate federated user account for business or professional purposes). The federated user account can be associated with an SSO token and an authentication token.

The client device 106 is representative of a plurality of client devices 106 that can be coupled to the network 112. The client device 106 can include, for example, a processor-based system such as a computer system. Examples of these computer systems can include a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications such as one or more client applications 193. A client application 193 can cause a user interface to be rendered on the display. The client application 193 can represent various types of applications executable by the client device 106. In some examples, the client applications 193 can include client side training service executables and other applications that work in concert with the management service 121. The client application 193 could be a web browser and the user interface could include a web page rendered within a browser window. As another example, a client application 193 can be an email application and the user interface could represent a graphical user interface for viewing, editing, and composing emails.

Additionally, the client application 193 can represent an application that facilitates user authentication with the authentication service 119 so that a user can create an association between a client device 106 and a user account 129. The client application 193 can also facilitate a single sign on service in concert with the components of the computing environment 103. The single sign on service can enable one or more of the client applications 193 to communicate with network services 111 as well as first party services executed by the computing environment 103. For example, these first and third party network services can include ticket services, workflow services, device management services, enterprise content services, email services, training program hosting services, and so on.

The network service 111 to which a third party service application 161 corresponds can require some form of user authentication before providing the third party service application 161 with user-specific data or information. For example, the network service 111 might be a salesforce tool pr ticketing tool that contains highly sensitive user and enterprise data. Accordingly, a client application 193 can include a management application that is communicatively linked to, and works in concert with, the management service 121. The client application 193 can also authenticate a user's access to the network service 111. Additionally, the client application 193 can also permit SSO according to examples of this disclosure. In this way, once a user has associated the network service 111 and other services with his or her user account 129 by authenticating with the identity manager 113, the identity manager 113 can also allow the user to access network services 111 that have federated their authentication to the identity manager 113.

The compliance policies 158, can include rules, settings, security profiles, and other configuration rules for enforcement of a predetermined set of states on a client device 106. The compliance policies 158 can also specify a threshold between one or more specific states of the device context data 188 that indicates that a spoof check or security check has failed. For example, a list of WiFi (or other) SSIDs identified and provided by a particular client device 106 can pass a peer-to-peer security check or spoof check if a peer client device 106 identifies a set of SSIDs that is the same or includes a threshold percentage of the SSIDs identified by the first client device 106. In some cases, the threshold difference between two devices can include a cross-comparison of one or more states that are expected to be shared between devices that are peer devices. Different states in the comparison can be weighted differently. For example, a GPS location can be weighted differently from a list of available WiFi SSIDs, and so on. Peer devices can include devices connected to a same network such as a BLE, Bluetooth, WiFi, ZigBee, or another peer-to-peer communications channel.

If there is a threshold difference between the respective device context data 188 of two different client devices 106, one of the client devices 106 can be spoofing or suspected of spoofing or falsifying data. The management service 121 can flag one or both of the client devices 106 as suspicious, and perform a remedial action for one or both of the client devices 106. The management service 121 can also perform a cross-comparison of one or both of the client devices 106 with another client device 106 in the same area.

The remedial action can include enterprise wiping the client device 106 by removing enterprise data and applications from the client device 106. The remedial action can include unenrolling the client device 106 from the management service 121, which can prevent the client device 106 from accessing enterprise data provided by the management computing environment 103 and the network services 111. The remedial action can include increasing a frequency at which the client device 106 or management agent 192 is directed to sample and provide heartbeat data (i.e., decrease a time between transmitting heartbeat data) to the management service 121 directly or through the peer-to-peer process described further below. The remedial action can include increasing a frequency that the management agent 192 is to sample and provide device context data 188 directly or through the peer-to-peer process described further below. The remedial action can include transmitting a notification to the client device 106 and/or to an administrator that the client device 106 has failed a security check and appears to be spoofing. The management service 121 can track a number of times that a particular client device 106 fails the cross-comparison process. The management service 121 can flag a device as suspicious after a predetermined number of failures, and can perform another remedial action after another predetermined number of failures.

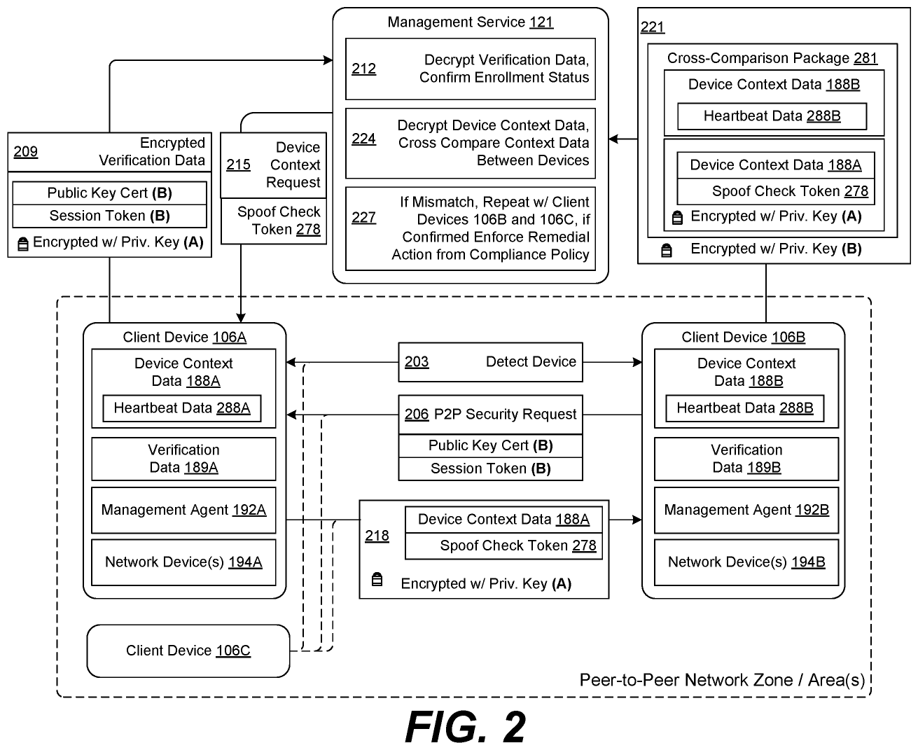

Referring next to FIG. 2, shown is a scenario that illustrates how interactions between the components of the networked environment 100 of FIG. 1 can operate. Generally, this example shows how the client devices 106A, 106B, 106C (the client devices 106) can interact using peer-to-peer communications to provide the management service 121 with their respective device context data 188. In this example, the management service 121 can identify a security status for the client device 106B, using a comparison with the client devices 106A, 106B.

Client devices 106A, 106B, and 106C can be in a same peer-to-peer zone or area. The peer-to-peer zone can refer to a zone or area associated with a network 112 accessible by multiple client devices 106A, 106B, and 106C. This can include an area where a WiFi, Bluetooth, or another network is accessible by the client devices 106A, 106B, and 106C. The network services 111 can be generated by one or more of the client devices 106, by a gateway or router device, or by another device.

In step 203, the client device 106B can detect a presence of the client device 106A. For example, the client device 106A can execute the management agent 192A, and the client device 106B can execute the management agent 192B. The management agents 192, or other management instructions executed by the client devices 106, can provide a peer-to-peer discovery API that pings for nearby client devices 106 using any one or more of the respective network devices 194A and 149B of the client devices 106. Specifically, the client device 106B can invoke the peer-to-peer discovery API, and the client device 106A can respond.

This device discovery ping can include a command, signal, or other predetermined discovery message that is unique to the management service 121 and/or a particular enterprise. The device discovery message is recognizable by the peer-to-peer discovery API or another management agent component. The peer-to-peer discovery API or another management agent component can respond using a predetermined response message that is unique to the management service 121 and/or a particular enterprise.

In step 206, the client device 106B can transmit a peer-to-peer security request that includes verification data 189B such as a public key peer-to-peer verification certificate (the public key certificate (B)) that can identify the client device 106B as owner of the public key and/or associated private key assigned to the client device 106B during enrollment of the client device 106B with the management service 121. The public key certificate (B) can also identify the entity that issued the certificate such as a certificate authority, the management service 121, or the client device 106B. The public key certificate (B) can also specify a period of time that the public key certificate (B) is valid.

In some cases, multiple client devices can be detected, and the management agent 192B can select the client device 106A that shares a user group 150 or a compliance policy 158 with the client device 106B. In some examples, the management agent 192B can transmit a list of detected client devices to the management service 121, and the management service 121 can select the client device 106A for the security request. The management service 121 can select the client device 106A that shares a user group 150 or a compliance policy 158 with the client device 106B, or can otherwise determine that the client device 106A is expected to have device context data 188A that is more similar to the device context data 188B than that of the other client devices 106 detected.

The verification data 189B can also include another device identifier (B), such as a UDID, UUID, GUID, or other unique device identifier for the client device 106B. The management agent 192B can sign or otherwise include the public key certificate (B) with the security request for authentication purposes. The verification data 189B can also include a unique time-based session token (B) generated by the management agent 192B at request generation time of the peer-to-peer security request. The verification data 189B can be specific to the client device 106B.

The management agent 192B can cause the client device 106B to transmit a peer-to-peer security request according to a predetermined frequency or period of time. The management agent 192B can keep a log of available peer client devices 106 such as the client devices 106A and 106C. The management service 121 can transmit or provide a command to the client device 106B in a command queue that can increase the predetermined frequency (decrease the period of time) if the client device 106B fails a spoof check, and can decrease the predetermined frequency (increase the period of time) if the client device 106B passes a spoof check.

In step 209, the client device 106A can transmit encrypted verification data 189B. The verification data 189B can include the public key cert (B) and the session token (B). The management agent 192A can include a private key (A) that was generated and provided by the management service 121, for example, upon enrollment. The private key (A) can be specific to the client device 106A. The management agent 192A can sign and/or symmetrically encrypt the verification data 189B using the private key (A). The client device 106A can then transmit the signed or encrypted verification data 189B to the management service 121.

In step 212, the management service 121 can decrypt the encrypted verification data 189B of client device 106B, which is encrypted using the private key (A) specific to client device 106A. The management service 121 can have access to a symmetrical or asymmetrical key for decryption of data encrypted using the private key (A). For example, management service 121 can have access to the public key (A), since it was provided as part of an enrollment process with the management service 121. If signed, the management service 121 can use an associated public key (A) to confirm the signature created using the private key (A).

The decrypted verification data 189B can include the public key certificate (B) and the session token (B), each of which are associated with the client device 106B. The management service 121 can verify the verification data 189B and confirm an enrollment status of the client device 106B. For example, the management service 121 can confirm that the public key certificate (B) and/or device identifier (B) matches data stored in association with the client device 106B and a user account 129. The management service 121 can confirm that the session token (B) matches an expected format, is generated using an expected token generation algorithm, and that the session token (B) is unexpired or is received within a predetermined time frame from a timestamp of the session token (B).

The timestamp can be included with, or embedded in the session token (B). The management service 121 can decrypt the session token (B) to determine that the session token (B) matches an expected format, is generated using an expected token generation algorithm, and can use decrypted token data to determine that the session token (B) is unexpired. The management service 121 can confirm that the public key certificate (B) matches a public key stored by the management service 121 for the client device 106B. The management service 121 can also identify an enrollment status associated with the client device 106B that is identified using the public key certificate (B) and/or device identifier (B).

In step 215, if the verification data 189B is valid, and the client device 106B is enrolled, then the management service 121 can transmit a device context request that includes a spoof check token 278. The management service 121 can transmit the spoof check token 278 to the client device 106A that provided the encrypted verification data 189B. The spoof check token 278 can be generated by the management service 121. The spoof check token can be the session token (B), encrypted using a “spoof check” specific private key stored as a secret by the management service 121.

In step 218, the management agent 192A of the client device 106A can package the spoof check token 278 along with device context data 188A and transmit the information to the client device 106B. The device context data 188A can include heartbeat data 288A, as well as the other device context data 188 as described. The heartbeat data 288A can include basic information about the client device 106A, such as a device identifier, operating system, hardware information, device model or type, and so on. The heartbeat data 288A can also include a heartbeat timestamp, and a period of time or frequency at which the heartbeat data 288A should be provided to the management service 121.

The management agent 192A can encrypt the spoof check token 278 and the device context data 188A using the private key (A) of the client device 106A. The management agent 192A can transmit the encrypted spoof check token 278 and the device context data 188A to the client device 106B. The encrypted spoof check token 278 and the device context data 188A together can be referred to as a preliminary or a partial cross-comparison package from the client device 106A. The client device 106B does not include the private key (A), and further does not include the spoof check private key of the management service 121, and so the encrypted cross-comparison package 281 is not decryptable by the client device 106B.

In step 221, the client device 106B can package its own device context data 188B along with the encrypted preliminary cross-comparison package, which includes the device context data 188A and the spoof check token 278. The device context data 188B can include the heartbeat data 288B, as well as device location data, sensor data, network data, peer device data, and other states and information. The heartbeat data 288B can include basic information about the client device 106B, such as a device identifier, operating system, hardware information, device model or type, and so on. The heartbeat data 288B can also include a heartbeat timestamp, and a period of time or frequency at which the heartbeat data 288B should be provided to the management service 121.

The management agent 192B can encrypt the device context data 188B and the encrypted preliminary cross-comparison package using the private key (B) of the client device 106B. The management agent 192B can transmit the resulting encrypted cross-comparison package 281 to the management service 121. The cross-comparison package 281 can include the device context data 188B, the device context data 188A, and the spoof check token 278. The cross-comparison package 281 can be encrypted as a whole using the private key (B), and the preliminary cross-comparison package can be encrypted within the package using the private key (A).

In step 224, the management service 121 can decrypt the device context data 188A and the device context data 188B from the cross-comparison package 281. The management service 121 can have access to the private key (A) and the private key (B), since they were assigned and provided to the respective client devices 106A and 106B upon enrollment. The management service 121 also has access to the spoof check private key. As a result, the management service 121 is the sole entity capable of decrypting all components of the cross-comparison package 281.

The management service 121 can then perform a cross-comparison between the device context data 188A and the device context data 188B, according to predetermined thresholds. If the differences between the device context data 188A and the device context data 188B exceed the predetermined threshold or thresholds, then the management service 121 can determine that there is a mismatch between the device context data 188A and the device context data 188B.

In step 227, the management service 121 can identify client device 106C as another nearby device in a peer-to-peer zone or area with the client device 106B. For example, the client device 106C can be a device that is detected in a manner similarly to the process indicated in step 203, and the client device 106C can report to the management service 121 that it detects the client device 106B. The client device 106B can also report to the management service 121 that it detects the client device 106C.

In some cases, multiple devices can be detected, and the management service 121 can select a device that shares a user group 150 or has a compliance policy 158 that is shared with the client device 106B. The management service 121 can select the client device 106C that shares a user group 150 or a compliance policy 158 with the client device 106B, or can otherwise determine that the client device 106C is expected to have device context data 188A that is more similar to the device context data 188B than that of the other client devices 106 detected, excluding the client device 106A. Steps 203-224 can be repeated using client device 106C in place of client device 106A. If there is a mismatch again, the management service 121 can enforce a remedial action indicated in the compliance policy 158 for the client device 106B.

The client device 106C can also be compared to client device 106A. In that example, the client devices 106 that have matching device context data 188 can be considered to have a security status of unspoofed or secure, while the mismatched client device 106 that is mismatched from the others can be considered to have a security status of spoofed or insecure, and a remedial action can be applied to the mismatched client device 106.

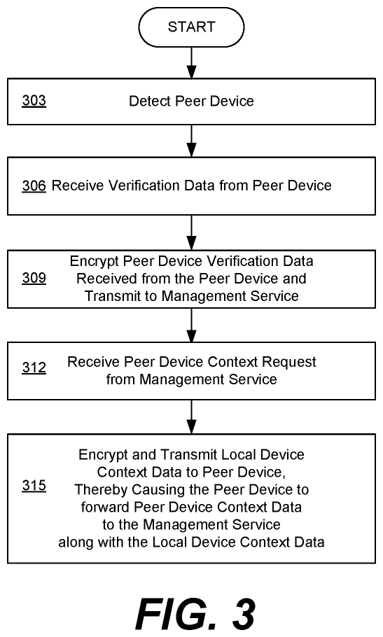

FIG. 3 shows a flowchart that describes how client devices 106 can interact using peer-to-peer communications to provide the management service 121 with their respective device context data 188. Specifically, this flowchart describes how a first client device 106 can receive peer-to-peer verification data 189 from a “peer” second client device 106, forward it to the management service 121 for verification, and send local device context data 188 of the first client device 106 to the second client device 106 to be included in a cross-comparison package 281 that also includes the peer device context data 188 of the second client device 106. While the steps can be discussed from the perspective of the first client device 106, other components of the networked environment 100 can perform aspects of the steps.

In step 303, the first client device 106 can detect a presence of the second client device 106. For example, each of the client devices 106 can execute a management agent 192 that includes a peer-to-peer discovery API or functionality. The first client device 106 can invoke the peer-to-peer discovery API, and the second client device 106 can respond. In some examples, the management agent 192 can enable a network device 194 and transmit or broadcast a peer-to-peer discovery message, which any other client devices 106 that include a management agent 192 will respond to. The peer-to-peer discovery API or functionalities of the respective client devices 106 can form a peer-to-peer communications channel or network.

In step 306, the first client device 106 can receive a peer-to-peer security request device verification data from the “peer” second client device 106 through the peer-to-peer channel established using the peer-to-peer discovery API or functionalities of the respective client devices 106. The first client device 106 can receive verification data 189 including a public key certificate of the second client device 106 and a unique time-based session token generated by the management agent 192 of the second client device 106.

In step 309, the first client device 106 can encrypt the peer-to-peer security request, including a public key certificate and the unique time-based session token received from the second client device 106, and transmit it to the management service 121. The first client device 106 can encrypt the peer-to-peer security request with a private key of the first client device 106. The private key of the first client device 106 can be a shared secret shared with the management service 121. The management service 121 can assign and provide the private key to the first client device 106 upon enrollment.

The management service 121 can decrypt the peer-to-peer security request, verify the authenticity or validity of its contents, and can determine that the second client device 106 is enrolled with the management service 121. The management service 121 can then use a spoof check private encryption key to encrypt the unique time-based session token from the peer-to-peer security request. The resulting spoof check token 278 can be transmitted to the first client device 106.

In step 312, the first client device 106 can receive a peer-to-peer device context request from the management service 121. The peer-to-peer device context request can include the spoof check token 278. The spoof check token 278 can be the unique time-based session token, encrypted using the spoof check encryption key stored as a secret by the management service 121.

In step 315, the first client device 106 can package its local device context data 188 with the spoof check token 278 and transmit it to the second client device 106. The peer-to-peer device context request can include instructions that invoke a device context API of the management agent 192 of the first client device 106. This device context API can cause the first client device 106 to package its local device context data 188 with the spoof check token 278 as a preliminary cross-comparison package. The device context API can encrypt the preliminary cross-comparison package with the private key of the first client device 106, and transmit the resulting encrypted preliminary cross-comparison package to the second client device 106.

This transmission can invoke a device context API of the management agent 192 of the second client device 106. The device context API can cause the second client device 106 to package its own device context data 188 with the preliminary cross-comparison package, forming a completed cross-comparison package. The second client device 106 can then encrypt the completed cross-comparison package with a private key of the second client device 106, and transmit the encrypted completed cross-comparison package to the management service 121 for cross-comparison.

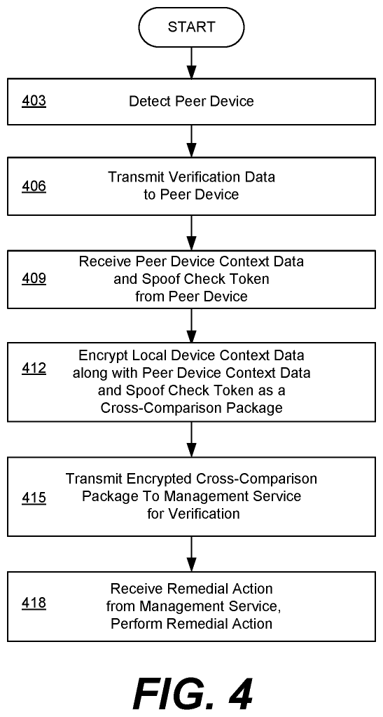

FIG. 4 shows a flowchart that describes how client devices 106 can interact using peer-to-peer communications to provide the management service 121 with their respective device context data 188. Specifically, this flowchart describes how a first client device 106 can transmit a peer-to-peer verification data 189 to a “peer” second client device 106, receive the second client device 106's “peer” device context data 188, and package the peer device context data 188 along with local device context data 188 of the first client device 106's as a cross-comparison package 281 for analysis by the management service 121. While the steps can be discussed from the perspective of the first client device 106, other components of the networked environment 100 can perform aspects of the steps.

In step 403, the first client device 106 can detect a presence of the second client device 106. For example, each of the client devices 106 can execute a management agent 192 that includes a peer-to-peer discovery API or functionality. The first client device 106 can invoke the peer-to-peer discovery API, and the second client device 106 can respond. In some examples, the management agent 192 can enable a network device 194 and transmit or broadcast a peer-to-peer discovery message, which any other client devices 106 that include a management agent 192 will respond to. The peer-to-peer discovery API or functionalities of the respective client devices 106 can form a peer-to-peer communications channel or network.

In step 406, the first client device 106 can transmit a peer-to-peer security request to the “peer” second client device 106 through the peer-to-peer channel established using the peer-to-peer discovery API or functionalities of the respective client devices 106. The peer-to-peer security request can attach verification data 189 of the first client device 106, including a public key certificate of the first client device 106 and a unique time-based session token generated by the management agent 192 of the first client device 106.

The second client device 106 can encrypt the peer-to-peer security request and transmit it to the management service 121. The management service 121 can decrypt the peer-to-peer security request, verify the authenticity or validity of its contents, and can confirm that the first client device 106 is enrolled. The management service 121 can then use a spoof check private encryption key to encrypt the unique time-based session token from the peer-to-peer security request. The resulting spoof check token 278 can be transmitted to the second client device 106, which generates and encrypts a preliminary cross-comparison package that includes the spoof check token 278 and peer device context data 188 of the second client device 106. The second client device 106 can transmit the encrypted preliminary cross-comparison package to the first client device 106.

In step 409, the first client device 106 can receive the encrypted preliminary cross-comparison package, which includes the spoof check token 278 and peer device context data 188 of the second client device 106. The first client device 106 can package its own local device context data 188 with the encrypted preliminary cross-comparison package, forming a completed cross-comparison package.

In step 412, the first client device 106 can encrypt the completed cross-comparison package with a private key of the second client device 106. The private key of the second client device 106 can be a shared secret with the management service 121, so the management service 121 can decrypt the completed cross-comparison package using the respective different private keys of the first client device 106 and the second client device 106. The management service 121 can also decrypt the spoof check token 278 using the spoof check private key or a decryption key that is a secret of the management service 121.

In step 415, the first client device 106 can transmit the encrypted cross-comparison package to the management service 121 for cross-comparison. The management service 121 can cross-compare the respective device context data 188 of the two client devices 106 according to predetermined thresholds. If there is a mismatch, the management service 121 can request another cross-comparison between the first client device 106 and a third client device 106.

Additionally or alternatively, the management service 121 can request a cross-comparison process to be performed between the second client device 106 and a third client device 106. If the third client device 106 device context data 188 matches that of the first client device 106, then the first client device 106 is not likely to be spoofing. However, if the third client device 106 device context data 188 does not match that of the first client device 106, or the third client device 106 device context data 188 matches that of the second client device 106, then the first client device 106 is likely to be spoofing. The management service 121 can flag the first client device 106 with a spoofing flag, and identify a remedial action according to a compliance policy 158.

In step 418, the first client device 106 can receive a remedial action from the management service 121. This can be received directly or the first client device 106 can retrieve a command to perform the remedial action from a command queue. The first client device 106 can then perform the remedial action, such as update its reporting frequency for device context data 188 or heartbeat frequency, perform an enterprise wipe, and other remedial actions.

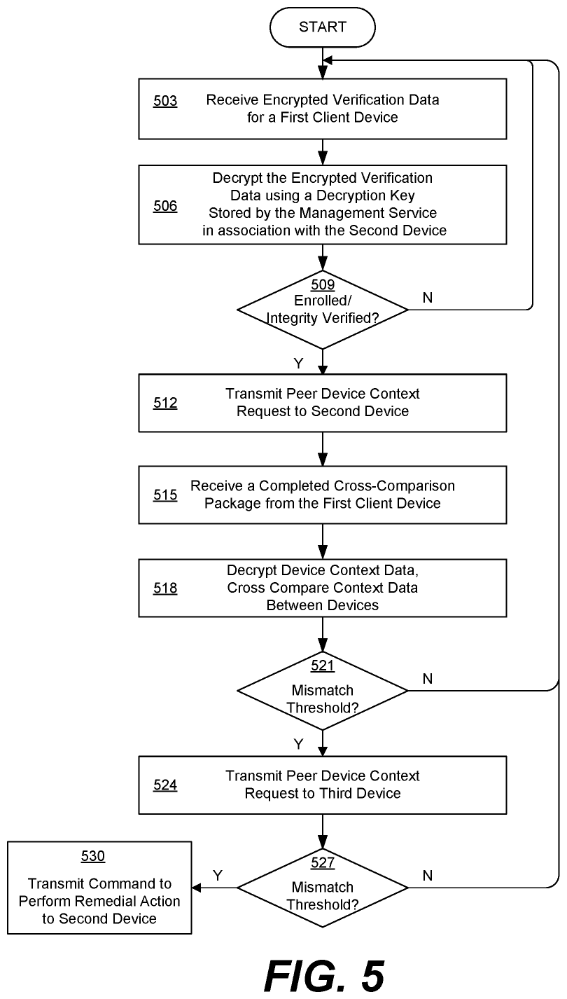

FIG. 5 shows a flowchart that describes how the management service 121 interacts with client devices 106 that use peer-to-peer communications to provide their respective device context data 188. Specifically, this flowchart describes how a management service 121 can verify enrollment of a first client device 106, direct a second client device 106 to initiate compilation of a cross-comparison package 281 that includes device context data 188 from both client devices 106, and perform the cross-comparison using this information. While the steps can be discussed from the perspective of the management service 121, other components of the networked environment 100 can perform aspects of the steps.

In step 503, the management service 121 can receive encrypted verification data 189 for a first client device 106. The management service 121 can receive the encrypted verification data 189 from a second client device 106. The second client device 106 can receive the verification data 189 of the first client device 106, and can encrypt it using its own private key. The private key of the second client device 106 can be a private key that is assigned to the second client device 106 based on its enrollment with the management service 121.

In step 506, the management service 121 can decrypt the encrypted verification data 189 using a cryptographic key associated with the second client device 106. For example, the management service 121 can have stored access to the private key of the second client device 106. The verification data 189 can include a public key certificate of the first client device 106 and a unique time-based session token generated by the first client device 106.

In step 509, the management service 121 can determine whether the verification data 189 for the first client device 106 indicates verified integrity or validity of the data. The management service 121 can also identify whether the first client device 106 is enrolled with the management service 121. If the verification data 189 is verified as valid and the first client device 106 is enrolled, then the process can move to step 512.

In step 512, the management service 121 can transmit a peer-to-peer device context request to the second client device 106. The peer-to-peer device context request can include a spoof check token 278. The spoof check token 278 can be the unique time-based session token, encrypted using a spoof check encryption key that is stored as a secret by the management service 121.

The second client device 106 can package its device context data 188 with the spoof check token 278 as a partial or preliminary cross-comparison package, and encrypt it using its private key. The second client device 106 can transmit the encrypted preliminary cross-comparison package to the first client device 106. The first client device 106 packages its own device context data 188 with the encrypted preliminary cross-comparison package as a completed cross-comparison package. The first client device 106 can then encrypt the completed cross-comparison package using its private key.

In step 515, the management service 121 can receive the completed cross-comparison package from the first client device 106. As indicated above, the second client device 106 sends a preliminary cross-comparison package to the first client device 106 in response to the peer-to-peer device context request, and the first client device 106 completes the cross-comparison package and transmits it to the management service 121.

In step 518, the management service 121 can decrypt the device context data 188 of the two client devices 106 from the completed cross-comparison package. The management service 121 can have access to the two private keys of the two client devices 106 as well as the spoof check private key.

In step 521, the management service 121 can determine whether the device context data 188 crosses a threshold that indicates a mismatch between the two client devices 106. The management service 121 can cross-compare the respective device context data 188 of the two client devices 106 according to predetermined thresholds. If there is a mismatch, the management service 121 can move to step 524.

In step 524, the management service 121 can request another peer device context request (i.e., a cross-comparison request) to a third client device 106 that is identified as a peer device to the first client device 106. This can cause the third client device 106 to send its device context data 188 to the first client device 106 as an encrypted preliminary cross-comparison package. The first client device 106 can complete the package using the same or updated device context data 188.

In step 527, the management service 121 can determine whether the device context data 188 crosses a threshold that indicates a mismatch between the third client device 106 and the first client device 106. If the third client device 106 device context data 188 matches that of the first client device 106, then the first client device 106 is not likely to be spoofing. However, if the third client device 106 device context data 188 does not match that of the first client device 106, or the third client device 106 device context data 188 matches that of the second client device 106, then the first client device 106 is likely to be spoofing, and the process moves to step 530.

In step 530, the management service 121 can transmit a command to perform a remedial action. The management service 121 can flag the first client device 106 with a spoofing flag, and identify a remedial action according to a compliance policy 158. The management service 121 can transmit a remedial action to the first client device 106. This can be transmitted directly or the management service 121 can place a command to perform the remedial action in a command queue for retrieval. In either case, the first client device 106 can receive the command and perform the remedial action, such as update its reporting frequency for device context data 188 or heartbeat frequency, perform an enterprise wipe, and other remedial actions.

The flowcharts and figures include examples of the functionality and operation of implementations of components described herein. The components described herein can include hardware, software, or a combination of hardware and software. If embodied in software, each element can represent a module of code or a portion of code that includes program instructions to implement the specified logical function(s). The program instructions can be embodied in the form of source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

Although the flowcharts and figures can show a specific order of execution, it is understood that the order of execution can differ from that which is shown. The order of execution of two or more elements can be switched relative to the order shown. Also, two or more elements shown in succession can be executed concurrently or with partial concurrence. Further, in some examples, one or more of the elements shown in the flowcharts can be skipped or omitted. In addition, any number of counters, state variables, warning semaphores, or messages could be added to the logical flow described herein, for purposes of enhanced utility, accounting, performance measurement, or troubleshooting aid. It is understood that all variations are within the scope of the present disclosure.

The components described herein can each include at least one processing circuit. The processing circuit can include one or more processors and one or more storage devices that are coupled to a local interface. The local interface can include a data bus with an accompanying address/control bus or any other suitable bus structure. The one or more storage devices for a processing circuit can store data or components that are executable by the one or processors of the processing circuit.

The components described herein can be embodied in the form of hardware, as software components that are executable by hardware, or as a combination of software and hardware. If embodied as hardware, the components described herein can be implemented as a circuit or state machine that employs any suitable hardware technology. This hardware technology can include one or more microprocessors, discrete logic circuits having logic gates for implementing various logic functions upon an application of one or more data signals, application specific integrated circuits (ASICs) having appropriate logic gates, programmable logic devices (e.g., field-programmable gate array (FPGAs), and complex programmable logic devices (CPLDs)).

Also, one or more or more of the components described herein that includes software or program instructions can be embodied in any non-transitory computer-readable medium for use by or in connection with an instruction execution system such as a processor in a computer system or other system. The computer-readable medium can contain, store, or maintain the software or program instructions for use by or in connection with the instruction execution system.

The computer-readable medium can include physical media, such as magnetic, optical, semiconductor, or other suitable media. Examples of a suitable computer-readable media include, but are not limited to, solid-state drives, magnetic drives, and flash memory. Further, any logic or component described herein can be implemented and structured in a variety of ways. One or more components described can be implemented as modules or components of a single application. Further, one or more components described herein can be executed in one computing device or by using multiple computing devices.

It is emphasized that the above-described examples of the present disclosure are merely examples of implementations to set forth for a clear understanding of the principles of the disclosure. Many variations and modifications can be made to the above-described examples without departing substantially from the spirit and principles of the disclosure. All modifications and variations are intended to be included herein within the scope of this disclosure.

Therefore, the following is claimed:

1. A non-transitory computer-readable medium comprising machine-readable instructions, wherein the instructions, when executed by at least one processor, cause at least one computing device to at least:
transmit, from a first client device to a second client device, verification data comprising: a public key verification certificate of the first client device, and a time-based session token generated by the first client device;
receive, by the first client device from the second client device, a preliminary cross-comparison package comprising: a spoof-check token, and peer device context data of the second client device;
generate, by the first client device, a cross-comparison package based on the preliminary cross-comparison package and local device context data of the first client device; and
transmit, by the first client device, the cross-comparison package to a management service for cross-comparison, the cross-comparison package comprising: the local device context data, the spoof-check token, and the peer device context data.

2. The non-transitory computer-readable medium of claim 1, wherein the instructions, when executed by the at least one processor, cause the at least one computing device to at least:
detect, by the first client device, that the second client device is accessible for peer-to-peer communications over a network.

3. The non-transitory computer-readable medium of claim 1, wherein the preliminary cross-comparison package is encrypted using a private key uniquely assigned to the second client device by the management service.

4. The non-transitory computer-readable medium of claim 1, wherein the cross-comparison package is encrypted using a private key uniquely assigned to the first client device by the management service.

5. The non-transitory computer-readable medium of claim 1, wherein the spoof-check token is an encrypted version of the time-based session token, which is encrypted by the management service to form the spoof-check token prior to being received by the second client device from the first client device.

6. The non-transitory computer-readable medium of claim 1, wherein the local device context data comprises at least one of: location data of the first client device, sensor data of the first client device, and network data of the first client device.

7. The non-transitory computer-readable medium of claim 1, wherein the instructions, when executed by the at least one processor, cause the at least one computing device to at least:
receive, from the management service, a command to perform a remedial action.

8. A system, comprising:
at least one computing device comprising at least one processor; and
a memory comprising machine-readable instructions, wherein the instructions, when executed by the at least one processor, cause the at least one computing device to at least:
transmit, from a first client device to a second client device, verification data comprising: a public key verification certificate of the first client device, and a time-based session token generated by the first client device;
receive, by the first client device from the second client device, a preliminary cross-comparison package comprising: a spoof-check token, and peer device context data of the second client device;
generate, by the first client device, a cross-comparison package based on the preliminary cross-comparison package and local device context data of the first client device; and
transmit, by the first client device, the cross-comparison package to a management service for cross-comparison, the cross-comparison package comprising: the local device context data, the spoof-check token, and the peer device context data.

9. The system of claim 8, wherein the instructions, when executed by the at least one processor, cause the at least one computing device to at least:
detect, by the first client device, that the second client device is accessible for peer-to-peer communications over a network.

10. The system of claim 8, wherein the preliminary cross-comparison package is encrypted using a private key uniquely assigned to the second client device by the management service.

11. The system of claim 8, wherein the cross-comparison package is encrypted using a private key uniquely assigned to the first client device by the management service.

12. The system of claim 8, wherein the spoof-check token is an encrypted version of the time-based session token, which is encrypted by the management service to form the spoof-check token prior to being received by the second client device from the first client device.

13. The system of claim 8, wherein the peer device context data comprises at least one of: location data of the second client device, sensor data of the second client device, and network data of the second client device.

14. The system of claim 8, wherein the instructions, when executed by the at least one processor, cause the at least one computing device to at least:
receive, from the management service, a command to perform a remedial action.

15. A method comprising:
transmitting, from a first client device to a second client device, verification data comprising: a public key verification certificate of the first client device, and a time-based session token generated by the first client device;
receiving, by the first client device from the second client device, a preliminary cross-comparison package comprising: a spoof-check token, and peer device context data of the second client device;
generating, by the first client device, a cross-comparison package based on the preliminary cross-comparison package and local device context data of the first client device; and
transmitting, by the first client device, the cross-comparison package to a management service for cross-comparison, the cross-comparison package comprising: the local device context data, the spoof-check token, and the peer device context data.

16. The method of claim 15, further comprising:
detecting, by the first client device, that the second client device is accessible for peer-to-peer communications over a network.

17. The method of claim 15, wherein the preliminary cross-comparison package is encrypted using a private key uniquely assigned to the second client device by the management service.

18. The method of claim 15, wherein the cross-comparison package is encrypted using a private key uniquely assigned to the first client device by the management service.

19. The method of claim 15, wherein the spoof-check token is an encrypted version of the time-based session token, which is encrypted by the management service to form the spoof-check token prior to being received by the second client device from the first client device.

20. The method of claim 15, wherein the local device context data and the peer device context data comprise at least one of: location data, sensor data, and network data.
